(19) United States
(12) Patent Application Publication
(10) Pub. No.: US 2004/0220778 A1
(43) Pub. Date: Nov. 4, 2004

(54) Remote maintenance system and stock management system

(76) Inventors: Kanehisa Imai, Chuo-ku (JP); Junji Shirai, Tamano-shi (JP); Toshio Yoshida, Tamano-shi (JP); Kiyoshi Fujiwara, Tamano-shi (JP); Hiromichi Fukuoka, Tamano-shi (JP)

Correspondence Address: Oliff & Berridge, PO Box 19928, Alexandria, VA, 22320, US

(21) Appl. No.: 10/484,919

(22) PCT Filed: Aug. 1, 2002
(86) PCT No.: PCT/JP02/07869

(30) Foreign Application Priority Data
Aug. 2, 2001 (JP) 2001-234444

(51) Int. Cl. G06F 15/00

(52) U.S. Cl. 702/188

(57) ABSTRACT

An object is to provide a remote maintenance system which can present a client with an avoiding action against the occurrence of an abnormality in the future. It is structured by a data measuring part 180 which measures operation data of a maintenance-receiving equipment of a client and outputs it, a residual lifetime predicting part 50 which receives the operation data outputted from the data measuring part 180 via the Internet 1, makes a diagnosis of the maintenance-receiving equipment, and predicts a residual lifetime of the maintenance-receiving equipment or its part, and a notifying part 40 which writes the result of the residual lifetime prediction by the residual lifetime predicting part 50 to an electric mail and notifies it to the client via the Internet 1.

### TECHNICAL FIELD

The present invention relates to a remote maintenance system using a communication network such as the Internet.

### BACKGROUND ART

Various remote maintenance systems using a communication network such as the Internet have been proposed. First, according to a representative remote maintenance system, a client regularly measures operation data of an equipment such as manufacturing facilities which is used by the client. A maintenance company obtains the operation data via the Internet. Then, it determines whether an abnormality is present or not in the operation data, and when the abnormality is present, it is notified to the client. According to the remote maintenance system like this, there is an advantage that the number of times an expert is dispatched as the personnel in charge of check to a machine which is actually used by the client can be reduced, and so on.

Meanwhile, in the case of a breakdown of the equipment such as the manufacturing facilities, it is necessary to repair it as soon as possible. Particularly, a breakdown of a crane of port facilities influences various fields to a great extent, for example, a cargo of a vessel cannot be landed and hence the vessel cannot leave, and therefore, it is necessary to start the operation again as soon as possible by replacing parts and so on. For this reason, the client generally has stocks of repair parts. The repair parts are the parts used for repairing.

However, a conventional remote maintenance system only determines whether the abnormality is present or not at the present time, and does not avoid the occurrence of the abnormality in the future. Hence, it can sense the occurred abnormality quickly, but it has the disadvantage that generation of a loss due to the occurrence of the abnormality is inevitable. Even though the system points out the possibility of the occurrence of the abnormality in the future, it cannot present what kind of avoiding action to be taken in concrete to the client. Therefore, inspection by the expert for selecting the avoiding action is necessary, and hence costs are hardly reduced.

In the meantime, the repair parts should be in stock while considering lifetime limits of the parts in service, which originally needs expert knowledge. However, there have been disadvantages that stock management with this kind of consideration is extremely troublesome and that the stock management operation is inefficient. Further, there has been the disadvantage it is inevitable that a large number of the repair parts are in stock in order to prepare for a sporadic breakdown of the machine.

### DISCLOSURE OF THE INVENTION

In view of the above disadvantages, an object of the present invention is to provide a remote maintenance system which presents a client with an avoiding action against the occurrence of an abnormality in the future and allows the client to take the avoiding action quickly.

Further, in view of the above disadvantages, an object of the present invention is to provide a remote maintenance system which allows stock management operation to increase efficiency and allows stocks to be minimized.

In order to attain the above objects, the remote maintenance system according to the present invention is structured by including a data measuring part with a data measuring means which is installed in a maintenance-receiving equipment of the client for measuring operation data of the maintenance-receiving equipment and outputting it, a storage part for receiving the operation data outputted from the data measuring part via a communication network and storing it, a residual lifetime predicting part for making a diagnosis of the maintenance-receiving equipment based on past operation data stored in the storage part and the latest operation data received via the communication network and predicting a residual lifetime of the maintenance-receiving equipment or its part, a notifying part for notifying the client of the result of the residual lifetime prediction by the residual lifetime predicting part via the communication network, a displaying part for receiving the result of the residual lifetime prediction by the residual lifetime predicting part via the communication network, displaying the received result of the residual lifetime prediction, and displaying part information concerning the maintenance-receiving equipment, to be used for determining whether the part needs to be restocked or not, and an ordering information outputting part for outputting ordering information of a repair part selected based on the result of the residual lifetime prediction and the part information displayed on the displaying part. Thereby, the client is able to find out which part should be replaced at which timing. Therefore, it is possible to present the client with the avoiding action against the occurrence of the abnormality in the future. It is possible for the client to place an order for the part quickly, and to quickly take the avoiding action against the occurrence of the abnormality in the future.

In the meantime, the remote maintenance system according to the present invention is structured by including a data measuring part with a data measuring means which is installed in a maintenance-receiving equipment of a client for measuring operation data of the maintenance-receiving equipment and outputting it, a storage part for receiving the operation data outputted from the data measuring part via a communication network and storing it, a residual lifetime predicting part for making a diagnosis of the maintenance-receiving equipment based on past operation data stored in the storage part and the latest operation data received via the communication network and predicting a residual lifetime of the maintenance-receiving equipment or its part, and a stock managing part for receiving a stock condition of repair parts in the client via the communication network, extracting the repair part having a fear of lack at lifetime limits of the parts in service calculated by the result of the residual lifetime prediction by the residual lifetime predicting part and instructing to supply the extracted repair part to the client. Thereby, it is not necessary for the client to manage ordering times of the repair parts, so that the efficiency of the stock management operation can be improved. Further, since the necessary number of the repair parts can be supplied when necessary, it is possible to minimize the stock. The lifetime limits can be calculated accurately while considering differences of the respective parts. Therefore, the efficiency of the stock management operation can be further improved and the stock can be further reduced.

### BRIEF DESCRIPTION OF DRAWINGS

FIG. 1 is a block diagram showing a remote maintenance system according to a first embodiment;

FIG. 2 is a view showing the structure of the remote maintenance system according to the first embodiment in concrete;

FIG. 3 is a flowchart of the remote maintenance system according to the first embodiment;

FIG. 4 is a flowchart showing an ordering procedure;

FIG. 5 is a block diagram showing a stock management system according to a second embodiment;

FIG. 6 is a view showing the structure of the stock management system according to the second embodiment in concrete; and

FIG. 7 is a flowchart of the stock management system according to the second embodiment.

### BEST MODE FOR CARRYING OUT THE INVENTION

Preferred embodiments of a remote maintenance system according to the present invention will be explained in detail with reference to the attached drawings. Incidentally, each of the following embodiments is only one mode of the present invention, and the present invention is not limited to these.

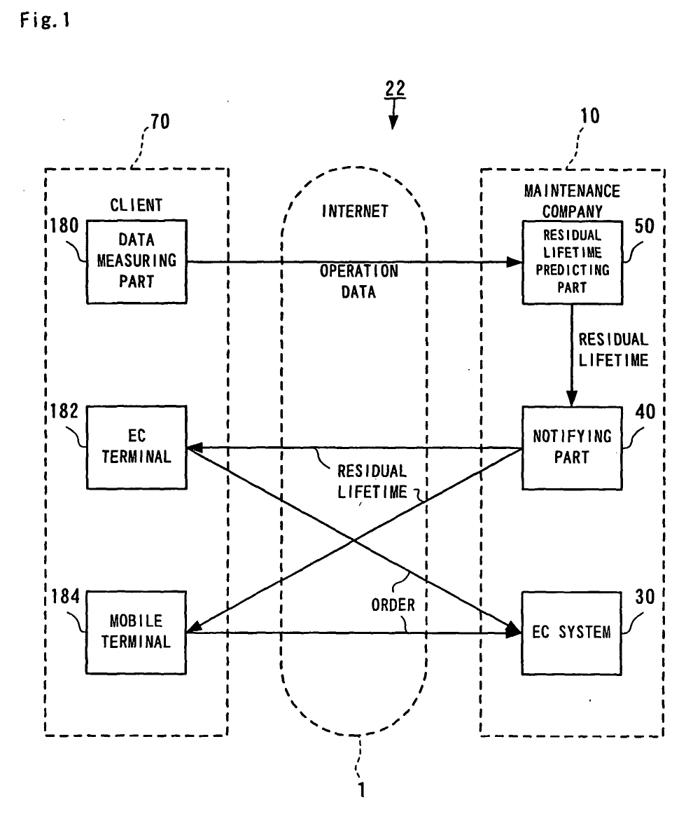

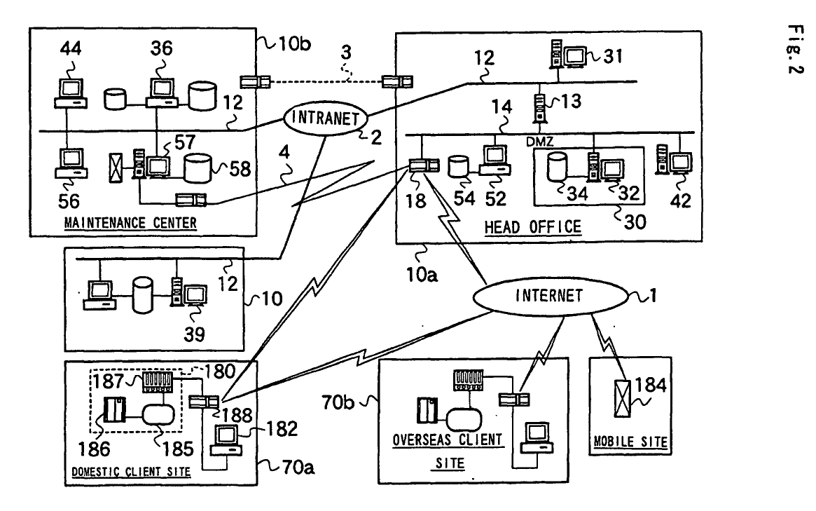

First, a first embodiment will be explained. FIG. 1 is a block diagram showing a remote maintenance system according to the first embodiment, and FIG. 2 is a view showing its structure in concrete. The remote maintenance system according to the first embodiment includes a data measuring part 180 which measures operation data of a maintenance-receiving equipment of a client 70 and outputs it, a storage part (database 58) which receives the operation data outputted from the data measuring part 180 via the Internet 1 and stores it, a residual lifetime predicting part 50 which makes a diagnosis of the maintenance-receiving equipment based on past operation data stored in the storage part and the latest operation data received via the Internet and predicts the residual lifetime of the maintenance-receiving equipment or its part (hereinafter referred to as the part or the like), and a notifying part 40 which writes the result of the residual lifetime prediction by the residual lifetime predicting part 50 to an electric mail and transmits it to the client. Further, it includes a displaying part (EC terminal 182) which receives the result of the residual lifetime prediction by the residual lifetime predicting part 50 via the Internet 1, displays the received result of the residual lifetime prediction, and displays part information concerning the maintenance-receiving equipment, which is used for determining whether the part needs to be restocked or not, and an ordering information outputting part (EC terminal 182) which outputs ordering information of a repair part selected based on the result of the residual lifetime prediction and the part information displayed on the displaying part.

The remote maintenance system according to the first embodiment is formed between a maintenance company 10 and the client 70. Incidentally, the maintenance company 10 is structured by a head office 10a and a maintenance center 10b. Further, the client 70 includes not only a domestic client site 70a but also an overseas client site 70b.

First, the data measuring part 180 is provided for measuring the operation data of the maintenance-receiving equipment of the domestic client site 70a and outputting it. The maintenance-receiving equipment is, for example, a gas turbine, a diesel engine, a container crane or the like. The data measuring part 180 is structured by a data measuring means 186, a data accumulating/transmitting device 185 and a hub 187. First, the data measuring means 186 in an operation state is installed. When the 5 maintenance-receiving equipment is the diesel engine, for example, a water temperature gauge for measuring the temperature of cooling water is provided as the data measuring means 186. Further, the data accumulating/transmitting device 185 for accumulating and transmitting the measured data is provided. Incidentally, an FIP server function is added to the data accumulating/transmitting device 185. Moreover, the hub 187 and a router 188 are provided so that the operation data can be transmitted. Further, the EC (Electronic Commerce) terminal is provided to the domestic client site 70a. The EC terminal constitutes the displaying part for displaying the result of the residual lifetime prediction, and constitutes the ordering information outputting part for outputting the ordering information of the part or the like. Meanwhile, the overseas client site 70b is also structured similarly to the above-described domestic client site 70a.

In the meantime, an intra-office LAN 12 which is connected via an intranet 2 is formed in the maintenance company 10. Incidentally, an INS connection 3 and a dial-up connection 4 are allowed to be used as backups in the case of a breakdown of the intranet 2. Further, a firewall 13 is connected to the LAN 12 to form a DMZ 14. The firewall 13 is a security system which is provided on the boarder between the inside and the outside of the network system, and has a function of improving safety of an internal system by controlling access from the outside. The DMZ 14 is a segment separated from an intra-office system formed by the firewall 13, and an illegal access to a public server on the DMZ 14 can be interrupted by an access controlling function of the firewall. Note that a router 18 is provided to the DMZ 14 so that it can be connected to the outside.

Moreover, the residual lifetime predicting part 50 which carries out the residual lifetime prediction of the part or the like is provided. In concrete, an FTP server 52 is first provided on the DMZ 14 of the head office 10a, thereby allowing the operation data to be received from the data measuring means 186. Further, a hard disk 54 is connected to the FI? server 52 so that the received operation data can be temporarily stored therein. Meanwhile, a data host server 57 and a database 58 are provided on the LAN 12 of the maintenance center 10b. The operation data which is temporarily stored in the hard disc 54 is transferred to the database 58. The database 58 constitutes the storage part for permanently storing the operation data. Meanwhile, a data analyzing means 56 is provided on the LAN 12, which allows analysis of the operation data, diagnosis of the maintenance-receiving equipment and residual lifetime prediction of the part or the like. Namely, the data analyzing means 56 functions as the residual lifetime predicting part. Incidentally, an original copy of an electric chart into which the result of the analysis by the data analyzing means 56 is filled is stored in the database 58, and further, its copy is stored in a later-described database server for EC 31.

Moreover, the notifying part 40 which notifies the client 70 of the residual lifetime which is predicted by the residual lifetime predicting part 50 is provided. The notifying part 40 is structured by an electric mail preparing means 44 and a mail server 42. First, the electric mail preparing means 44 is provided on the LAN 12 of the maintenance center 10b so that an electric mail, to which the result of the diagnosis by the data analyzing means 56, the result of the residual lifetime prediction and the like are written, can be prepared. Meanwhile, the mail server 42 is provided on the DMZ 14 of the head office 10a so that the prepared electric mail can be transmitted to the client 70.

In the meantime, an EC system 30 which provides the part information concerning the maintenance-receiving equipment and receives an order for the repair part is provided. The EC system 30 is structured by a parts book database 34 and a WEB server 32. First, the parts book database 34 is provided on the DMZ 14 of the head office 10a, into which a copy of a parts book prepared by a parts book preparing system 36 is stored. The parts book is structured by respective files of a general view of the maintenance-receiving equipment, exploded views, and part views containing the part information. The general view is first displayed, and when a part thereof is selected, the exploded view of that part is displayed, and further, when a part thereof is selected, the part view of the part is allowed to be displayed, thereby facilitating search of the part. Further, the WEB server 32 is connected to the parts book database 34 so that the parts book can be viewed from the outside.

Meanwhile, a file of an order form is created on the WEB server 32. Information about a concerned party such as the name of the client, the name of a requesting office department and the name of an input person, part information such as the name of the part and the code of the part, information about a contract such as a requesting number, requesting delivery date, its price and a payment method, and so on are allowed to be inputted to the order form. Further, a list of a plurality of the part information is displayed so that these can be ordered at the same time. Incidentally, it is preferable to set a requesting button in the part view of the parts book so that the part information of the part is automatically inputted into the order form by selecting it. Thereby, it is possible to avoid the mistake in transcription to the order form.

In the meantime, a quotation preparing program is formed on the WEB server 32. The quotation preparing program prepares a quotation based on an order which is the order form with requirements being inputted. Incidentally, the database server for EC 31 is provided on the LAN 12 of the head office 10a so that the latest information which is necessary for business, such as a selling price and a stock condition of the part, can be held therein. The WEB server 32 downloads the latest information from the database server for EC 31, and prepares the quotation. Further, the WEB server 32 downloads the electric chart from the database server for EC 31, and subjects it to be viewed by the client.

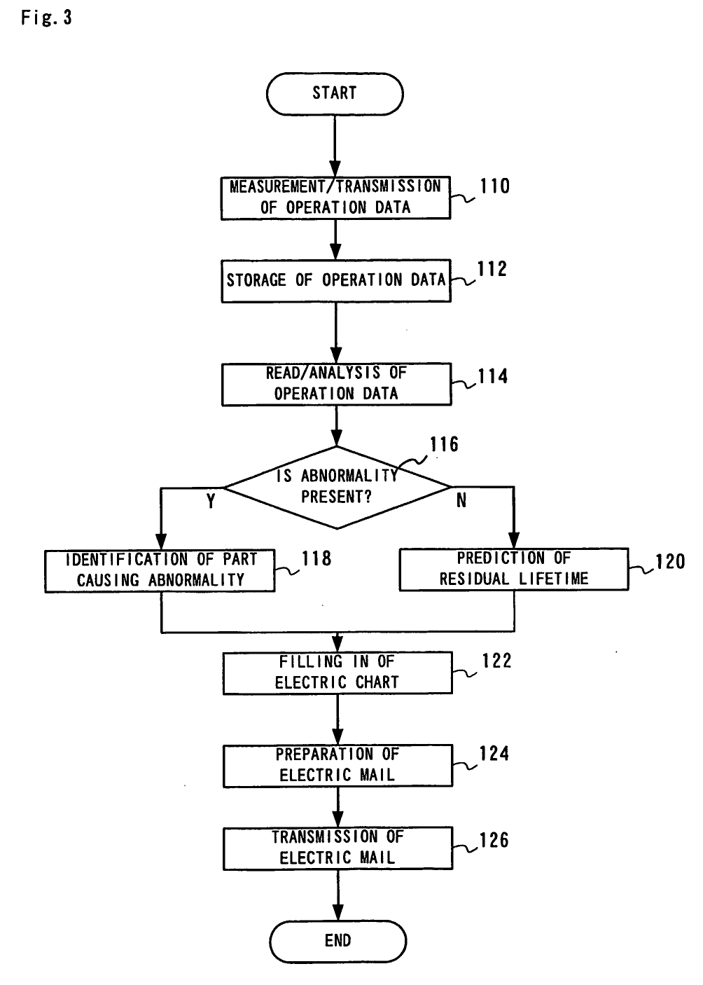

A method of using thus-structured remote maintenance system according to the first embodiment will be explained by using FIG. 2. Incidentally, FIG. 3 shows a flowchart of the remote maintenance system according to the first embodiment.

First, the data measuring means 186 measures the operation data of the maintenance-receiving equipment (step 110). Usually, the operation data is measured regularly at a frequency of approximately once a day. Incidentally, the measurement is carried out more frequently under abnormal conditions, and the measurement is specially carried out when requested from the maintenance center so that the nature and the reason of the abnormality can be grasped and normalized at an early stage. The measured operation data is transmitted from the data accumulating/transmitting device 185 to the head office 10a. It should be noted that, only when the operation data exceeds a predetermined threshold and is determined to be abnormal, the operation data may be transmitted with an electric mail of the purport. By directly connecting from the domestic client site 70a by the dial-up and connecting from the overseas client site 70b via the Internet 1, it is preferable to reduce communication costs in both of the cases.

Meanwhile, in the head office 10a, the FTP server 52 receives the operation data and temporarily stores it in the hard disc 54. Thereafter, it is transferred to the maintenance center 10b. In the maintenance center 10b, the data host server 57 receives it and permanently stores it in the database 58 (step 112).

Next, the data analyzing means 56 reads the operation data from the database 58 and analyzes the operation data (step 114). The data analyzing means 56 first makes a diagnosis whether the abnormality is present or not in the maintenance-receiving equipment (step 116). The presence of the abnormality is determined based on whether its temperature and vibration tend to increase with respect to the past operation data and operation data of the maintenance-receiving equipment of the same kind, and the like. When the abnormality is present, the part which needs to be replaced, out of the parts or the like causing the abnormality, is identified (step 118). When the abnormality is not present, the residual lifetime of the part or the like is predicted (step 120). The residual lifetime is predicted from, for example, decreasing tendency of the function of the part or the like, and so on.

Then, the result of the analysis by the data analyzing means 56 is filled into the electric chart which is stored in the database 58 (step 122). The electric chart is formed for each maintenance-receiving equipment, and the history of the maintenance such as the part replacement and the like are written therein, as well as the result of the analysis by the data analyzing means 56.

Further, the result of the analysis by the data analyzing means 56 is transferred to the mail preparing means 44, and the mail preparing means 44 prepares the electric mail based on it (step 124). When it is determined that the abnormality is present in the maintenance-receiving equipment, it is written in the electric mail together with the part or the like identified to need the replacement. In the meantime, when it is determined that the abnormality is not present in the maintenance-receiving equipment, it is written in the electric mail together with the result of the residual lifetime prediction of the part or the like. Incidentally, in both of the cases, it is suitable to prepare the electric mail by using the electric chart into which the result of the diagnosis is filled as it is. Further, in both of the cases, it is preferable to append to the electric mail the newest technology information concerning the part or the like. Thus, it is possible for the client to obtain the newest technology information when necessary and to update the maintenance-receiving equipment, and at the same time, it is possible for the maintenance company to increase opportunities to receive orders for the part or the like of the latest type.

Thus-prepared electric mail is transmitted to the domestic client site 70a and the overseas client site 70b, through the mail server 42 of the head office 10a (step 126). Incidentally, when it is determined that the abnormality is present in the maintenance-receiving equipment, the electric mail is also transmitted to a mobile terminal 184 such as a cellular phone of the client at the same time, thereby allowing a quick response. Incidentally, in the above example, it is structured to use the electric mail as the notifying means to the client, but it is not restrictive, and a telephone, a facsimile and the like may be used as the notifying means.

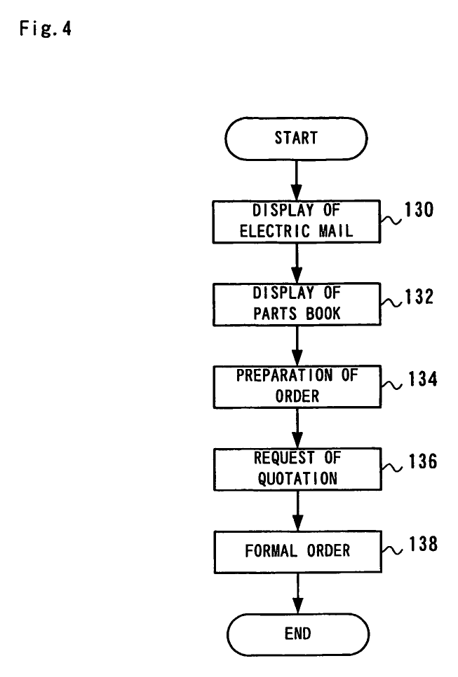

Next, the client places an order for the part. FIG. 4 shows a flowchart showing an ordering procedure. First, the electric mail which is received by the client is displayed on the EC terminal 182 (step 130). Next, the parts book is displayed on the EC terminal 182 (step 132). In concrete, an access is first made from the EC terminal 182 to the WEB server 32 in the head office. Incidentally, a URL is given to each client, and a user ID and a password are given to each office department inside the client, thereby keeping security. By inputting these, an access is made to the parts book of the maintenance-receiving equipment taken charge by each office department of the client, which is displayed on the EC terminal 182. In the parts book, the general view of the maintenance-receiving equipment is first displayed, and, by selecting a part thereof, the exploded view of the part is displayed, and further, by selecting a part thereof, the part view and the part information of the part are displayed. Incidentally, it is also possible to download the electric chart which is stored in the database server for EC 31 to the WEB server 32 and display it. Then, the client decides whether the part needs to be restocked or not based on these, and, when it is decided to be necessary, places the for the part.

Here, the order is prepared for ordering the part (step 134). The order is formed by inputting the requirements into the order form. The information about the concerned party, the part information, the information about the contract and so on are inputted into the order form. Incidentally, the requesting button is set in the part view of the parts book so that the part information of the part is automatically inputted into the order form by selecting it. Further, it is possible to display a list of a plurality of the part information so that these can be ordered at the same time.

Moreover, the client can make a request to prepare the quotation before a formal order (step 136). The quotation preparing program in the WEB server 32 downloads the business information such as the selling price from the database server for EC 31, based on the order which is formed as above, and prepares the quotation. Further, the client can make inquiries to the WEB server 32 whether the part is in stock or not, when the ordering part is scheduled to be delivered, and so on, and the WEB server 32 answers the client by downloading necessary information from the database server for EC 31.

The client confirms the details of the quotation, and places the formal order (step 138). The ordering information is outputted from the EC terminal 182 to the WEB server 32 of the head office 10a.

According to thus-structured remote maintenance system of the first embodiment, it is possible to present the client with an avoiding action against the occurrence of the abnormality in the future. In this point, a conventional remote maintenance system only determines whether the abnormality is present or not at the present time, and does not avoid the occurrence of the abnormality in the future. Even though the system points out the possibility of the occurrence of the abnormality in the future, it cannot present what kind of action to be taken in concrete to the client.

However, the remote maintenance system according to the first embodiment is structured by including the data measuring part which measures the operation data of the maintenance-receiving equipment of the client and outputs it, the storage part which receives the operation data outputted from the data measuring part via the Internet and stores it, the residual lifetime predicting part which makes the diagnosis of the maintenance-receiving equipment based on the past operation data stored in the storage part and the latest operation data received via the Internet and predicts the residual lifetime of the part or the like, and the notifying part which writes the result of the residual lifetime prediction by the residual lifetime predicting part to the electric mail and transmits it to the client.

The residual lifetime predicting part analyzes the operation data and determines whether the abnormality is present in the maintenance-receiving equipment or not, and, when the abnormality is present, identifies the part or the like which needs to be replaced, and, when the abnormality is not present, predicts the residual lifetime of the part or the like. Further, when the abnormality is present, a mail transmitting part writes it in the electric mail together with the part or the like identified to need the replacement, and in the meantime, when the abnormality is not present, it writes it in the electric mail together with the result of the residual lifetime prediction of the part or the like, and transmits these to the client in both of the cases. Thereby, the client is able to find out which part should be replaced at which timing. Therefore, it is possible to present the client with an avoiding action against the occurrence of the abnormality at the present time, and what is more, it is possible to present the client with the avoiding action against the occurrence of the abnormality in the future.

Further, since a large amount of the operation data can be obtained and hence the correct residual lifetime can be predicted by using the Internet, it is possible to present the avoiding action accurately against the occurrence of the abnormality in the future. Thereby, inspection by an expert for selecting the avoiding action becomes unnecessary, and a large number of the repair parts need not to be in stock in order to prepare for the sporadic breakdown of a machine. Therefore, the client side has the advantage of reducing management costs. Further, it is possible to ensure reliability of the network and to reduce the communication costs by using the established Internet system. Meanwhile, on the maintenance center side, it is possible to increase order reception of the maintenance-receiving equipment or its parts by providing the remote maintenance system with the above-described various advantages.

In the meantime, the remote maintenance system according to the first embodiment is structured by including the displaying part which receives the result of the residual lifetime prediction by the residual lifetime predicting part via the Internet, displays the received result of the residual lifetime prediction, and displays the part information concerning the maintenance-receiving equipment, which is used for determining whether the part needs to be restocked or not, and the ordering information outputting part which outputs the ordering information of the repair part selected based on the result of the residual lifetime prediction and the part information displayed on the displaying part. Thereby, it is possible for the client to place the order for the part quickly, and to quickly take the avoiding action against the occurrence of the abnormality in the future.

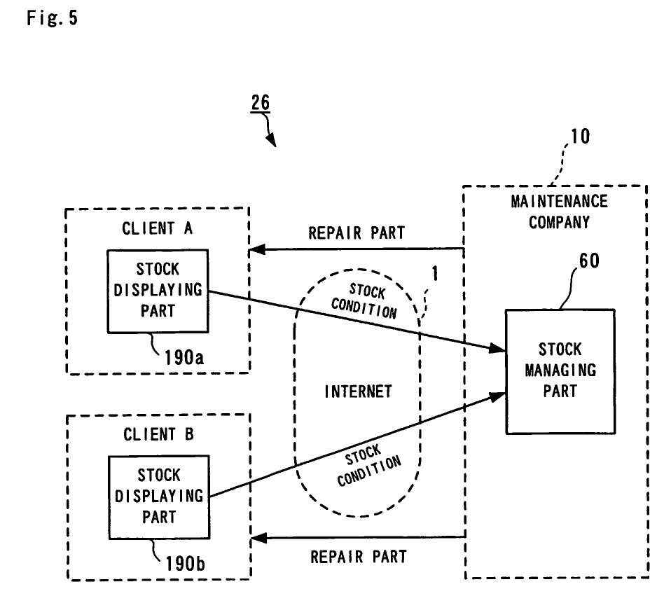

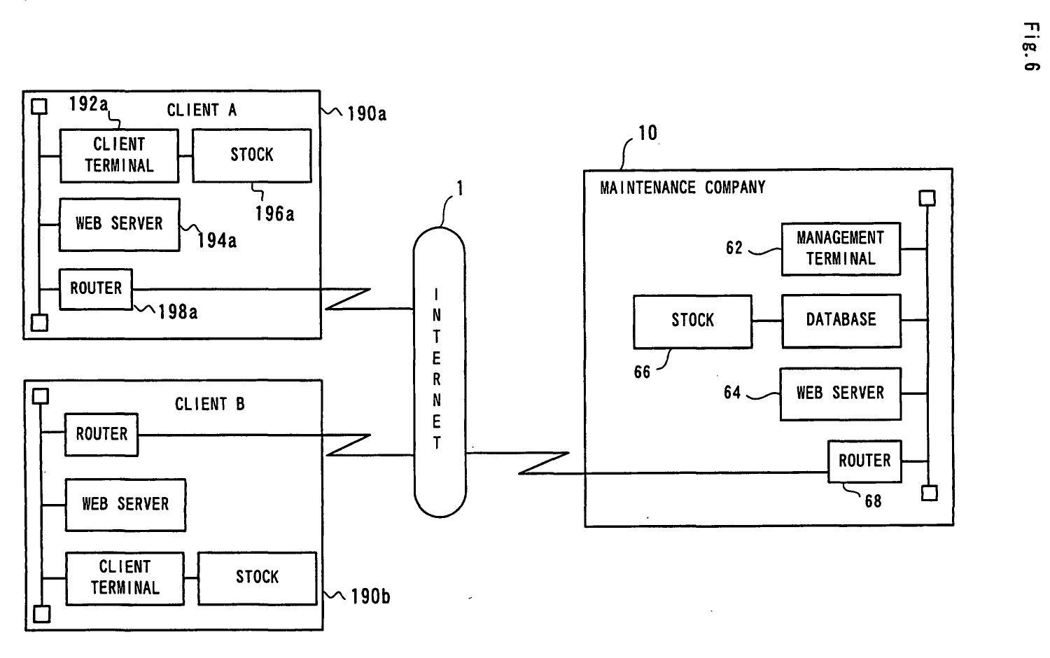

Next, a second embodiment will be explained. FIG. 5 is a block diagram showing a stock management system according to the second embodiment, and FIG. 6 is a view showing its structure in concrete. The stock management system according to the second embodiment includes a stock displaying part which displays stock conditions of the repair parts in clients, and a stock managing part which obtains the stock conditions displayed by the stock displaying part via the Internet, extracts the repair part having a fear of lack at the lifetime limits of the parts in service, and instructs to supply the repair part.

A client A has a stock 196a of the repair parts, and records its condition to a client terminal 192a. The stock condition of the client A is allowed to be viewed from the outside via the Internet 1, thereby forming a stock displaying part 190a. In concrete, a WEB server 194a is formed on the LAN of the client A, into which the file of the stock condition of the repair parts is stored. In viewing, input of a password may be requested. Incidentally, a WEB server of an Internet provider may be used as the WEB server 194a. Incidentally, a stock displaying part 190b is formed in a client B as well. Meanwhile, a stock 66 for the repair parts is also prepared in a maintenance company 10. Similarly to the clients' side, it is preferable to provide a WEB server 64 into which the file of the stock condition is stored, and allow it to be viewed from the outside via the Internet 1.

In the meantime, a stock managing part 60 is formed on the LAN of the maintenance company 10. In concrete, a managing terminal 62 is provided as the stock managing part 60 so that the stock conditions of the clients are regularly viewed and the stocks of the clients are unitarily managed by the following method.

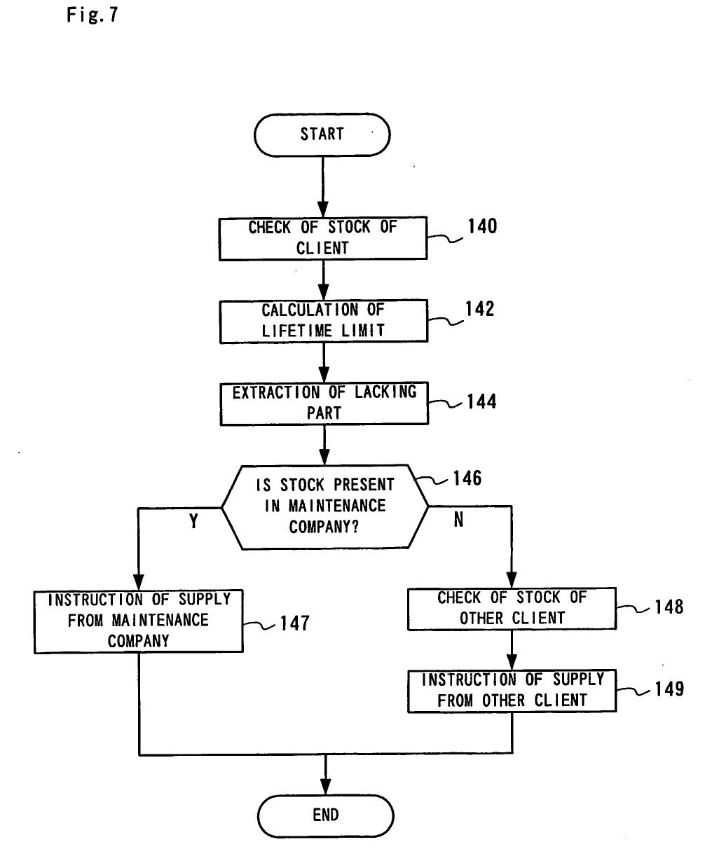

Thus-structured stock management system 26 is used as follows. FIG. 7 shows a flowchart of the stock management system according to the second embodiment.

First, the stock managing part 60 regularly checks a file of the stock condition which is stored in the WEB server of each client (step 140). Next, the lifetime limits of the respective parts which are actually in service in the machine of the client are calculated (step 142). Incidentally, the lifetime limit of each part is calculated from the history of the maintenance, an average lifetime of the parts of the same kind in the machines of the same kind, and the like. Then, the repair part having the fear of lack at the calculated lifetime limit is extracted (step 144).

It is a matter of course that the breakdown may occur earlier than the lifetime limit calculated from the average lifetime, because of the differences of the respective parts. Therefore, when the result of the residual lifetime prediction by the residual lifetime predicting part according to the first embodiment is used, the lifetime limits can be calculated accurately from the residual lifetimes of the respective parts which are actually in service. Then, the repair part having the fear of lack at the calculated lifetime limit can be extracted accurately.

Next, the stock managing part 60 instructs to supply the extracted repair part to the client. As its precondition, it checks whether the repair part is in stock or not in the maintenance company 10 (step 146). When it is in stock in the maintenance company 10, it instructs to supply the repair part from the stock (step 147). Meanwhile, when it is not in stock in the maintenance company 10 and in the case of emergency such as the case where the breakdown is actually occurring, the stock managing part 60 checks the stock condition of the other client B (step 148). When the repair part is in stock in the client B, it instructs to supply from a warehouse of the client B (step 149). In this case, the part is supplied to the client A after the office department in charge consults with the client B.

By using thus-structured stock management system according to the second embodiment like the above, it is possible to increase the efficiency of stock management and to minimize the stock. In this point, there have been the disadvantages that the stock management while considering the lifetimes of the respective parts is quite troublesome and that the stock management operation is inefficient. Further, there has been the disadvantage that it is inevitable that a large number of the parts need to be in stock in order to prepare for the sporadic breakdown of the machine.

However, the stock management system according to the second embodiment is structured by including the stock displaying part which displays the stock conditions of the repair parts in the clients, and the stock managing part which obtains the stock conditions of the repair parts displayed by the stock displaying part via the Internet, extracts the repair part having the fear of lack at the lifetime limits of the parts in service, and instructs to supply the repair part. Thereby, it is not necessary for the client to manage the ordering times of the repair parts, so that the efficiency of the stock management operation can be improved. Further, since the necessary number of the parts can be supplied when necessary, it is possible to minimize the stock.

Moreover, it is possible to ensure reliability of the network and to reduce the communication costs by using the established Internet system. Meanwhile, on the maintenance company side, it is possible to increase the order reception of the maintenance-receiving equipment and its parts by providing the stock management system with the above-described various advantages.

### INDUSTRIAL AVAILABILITY

Since it is structured by including the data measuring part which measures the operation data of the maintenance-receiving equipment of the client and outputs it, the storage part which receives the operation data outputted from the data measuring part via a communication network and stores it, the residual lifetime predicting part which makes the diagnosis of the maintenance-receiving equipment based on the past operation data stored in the storage part and the latest operation data received via the communication network and predicts the residual lifetime of the maintenance-receiving equipment or the part, and the notifying part which notifies the client of the result of the residual lifetime prediction by the residual lifetime predicting part via the communication network, the client is able to find out which part should be replaced at which timing. Therefore, it is possible to present the client with the avoiding action against the occurrence of the abnormality in the future.

1. A remote maintenance system comprising:
a data measuring part with a data measuring means which is installed in a maintenance-receiving equipment of a client for measuring operation data of the maintenance-receiving equipment and outputting it;
a storage part for receiving the operation data outputted from said data measuring part via a communication network and storing it;
a residual lifetime predicting part for making a diagnosis of the maintenance-receiving equipment based on past operation data stored in said storage part and the latest operation data received via the communication network and predicting a residual lifetime of the maintenance-receiving equipment or its part;
a notifying part for notifying the client of the result of the residual lifetime prediction by said residual lifetime predicting part via the communication network;
a displaying part for receiving the result of the residual lifetime prediction by said residual lifetime predicting part via the communication network, displaying the received result of the residual lifetime prediction, and displaying part information concerning the maintenance-receiving equipment, to be used for determining whether the part needs to be restocked or not; and
an ordering information outputting part for outputting ordering information of a repair part selected based on the result of the residual lifetime prediction and the part information displayed on said displaying part.

2. (Canceled)

3. A remote maintenance system comprising:
a data measuring part with a data measuring means which is installed in a maintenance-receiving equipment of a client for measuring operation data of the maintenance-receiving equipment and outputting it;
a storage part for receiving the operation data outputted from said data measuring part via a communication network and storing it;
a residual lifetime predicting part for making a diagnosis of the maintenance-receiving equipment based on past operation data stored in said storage part and the latest operation data received via the communication network and predicting a residual lifetime of the maintenance-receiving equipment or its part; and
a stock managing part for receiving a stock condition of repair parts in the client via the communication network, extracting the repair part having a fear of lack at lifetime limits of the parts in service calculated by the result of the residual lifetime prediction by said residual lifetime predicting part and instructing to supply the extracted repair part to the client.

4. (Canceled)
